(19) United States
(12) Patent Application Publication
(10) Pub. No.: US 2010/0110614 A1
(43) Pub. Date: May 6, 2010

(54) SOLID ELECTROLYTIC CAPACITOR

(75) Inventors: Takashi UMEMOTO, Hirakata-city (JP); Koji ENDO, Hirakata-city (JP); Hiroshi NONOUE, Hirakata-city (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi-city (JP)

(21) Appl. No.: 12/606,330

(22) Filed: Oct. 27, 2009

(30) Foreign Application Priority Data
Oct. 31, 2008 (JP) 2008-281716
Oct. 31, 2008 (JP) 2008-281717

(51) Int. Cl. H01G 9/025; H01G 9/15

(52) U.S. Cl. 361/525

(57) ABSTRACT

A solid electrolytic capacitor includes: an anode made of a valve metal or an alloy of a valve metal; a dielectric layer formed on the surface of the anode; an electrolyte layer formed on the dielectric layer; a cathode layer formed on the electrolyte layer; and a resin outer package covering a capacitor element composed of the anode, the dielectric layer, the electrolyte layer and the cathode layer. The electrolyte layer is composed of a first electrolyte region provided on the dielectric layer, a second electrolyte region provided on the first electrolyte region and in contact with the cathode layer, and a third electrolyte region provided, in a portion of the electrolyte layer on which the cathode layer is not provided, in contact with the second electrolyte region or the first electrolyte region.

### BACKGROUND OF THE INVENTION

1. Field of the Invention

This invention relates to solid electrolytic capacitors using a valve metal or an alloy of a valve metal as an anode.

2. Description of Related Art

Generally, solid electrolytic capacitors use a porous valve metal body as an anode. The porous body is obtained by pressing particulate powder of a valve metal, such as tantalum (Ta) or niobium (Nb), together with an anode lead into a formed body and sintering the formed body. The anode is then anodized to form a dielectric layer made mainly of an oxide of the above metal on its surface. On the dielectric layer is then formed an electrolyte layer made of a conducting polymer, such as polypyrrole or polythiophene. Thereafter, a cathode layer is formed on the electrolyte layer, thereby obtaining a capacitor element. To the capacitor element are joined an anode terminal and a cathode terminal. Then, a resin outer package is formed on the capacitor element by transfer molding using resin, such as epoxy resin, to cover the capacitor element with the resin, thereby obtaining a solid electrolytic capacitor.

To improve the solder heat resistance of such a solid electrolytic capacitor, Published Japanese Patent Application No. H01-297811 proposes a solid electrolytic capacitor that uses a solid electrolyte made of a composite of a conducting polymer compound and fine particles of an inorganic substance or inorganic compound having a linear expansion coefficient of 1×10⁻⁵ (K⁻¹) or less and a melting point of 260° C. or more.

In a solid electrolytic capacitor having such a composition, however, the solid electrolyte has large differences in linear expansion coefficient from the metal paste layer in the cathode layer and the package resin. Therefore, when the solid electrolytic capacitor undergoes a heat cycle test, the differences in linear expansion coefficient may cause delamination or the formation of defects, which deteriorates the capacitor characteristics.

Meanwhile, solid electrolytic capacitors using a conducting polymer as an electrolyte layer have the problem of large leakage current.

To solve the above problems, Published Japanese Patent Application No. H08-213285 proposes that on a conducting polymer layer is formed a second conducting polymer layer containing fine powder of a hard material.

On the other hand, to further reduce the equivalent series resistance (ESR) of a solid electrolytic capacitor, Published Japanese Patent Application No. 2000-133551 proposes that on the surface of a solid electrolyte layer is formed an intermediate conducting polymer layer having a smaller hardness than the solid electrolyte layer.

Published Japanese Patent Application No. H08-213285 describes that the second conducting polymer layer can protect the oxide film from external mechanical stress, thereby reducing the leakage current. However, the inventors' studies have found that the reduction of the increase in leakage current is insufficient.

Published Japanese Patent Application No. 2000-133551 describes that since the intermediate conducting polymer layer is made of a soft material, the intermediate layer can be brought into close contact with carbon particles to increase the contact area between the carbon particles and the intermediate layer, which reduces the contact resistance and reduces the ESR. However, the inventors' studies have found that the ESR reduction effect is insufficient.

In addition, both the techniques disclosed in Published Japanese Patent Application Nos. H08-213285 and 2000-133551 have the problem that when the solid electrolytic capacitor is held at high temperature, the capacitance decreases.

### SUMMARY OF THE INVENTION

A first object of the present invention is to provide a solid electrolytic capacitor that can reduce the leakage current without increasing the ESR.

A second object of the present invention is to provide a solid electrolytic capacitor that can increase the reliability at high temperatures.

### <First Aspect of the Invention>

A solid electrolytic capacitor according to a first aspect of the present invention includes: an anode made of a valve metal or an alloy of a valve metal; a dielectric layer formed on the surface of the anode; an electrolyte layer formed on the dielectric layer; a cathode layer formed on the electrolyte layer; and a resin outer package covering a capacitor element composed of the anode, the dielectric layer, the electrolyte layer and the cathode layer, wherein the electrolyte layer is composed of a first electrolyte region provided on the dielectric layer, a second electrolyte region provided on the first electrolyte region and in contact with the cathode layer, and a third electrolyte region provided in contact with a portion of the second electrolyte region or the first electrolyte region on which the cathode layer is not provided.

In the first aspect of the present invention, for example, the portion of the electrolyte layer on which the cathode layer is not provided may be composed of the first, second and third electrolyte regions formed in this order on the dielectric layer or may be composed of the first and third electrolyte regions formed in this order on the dielectric layer. In the first aspect of the present invention, like this, the portion of the electrolyte layer on which the cathode layer is not provided may not include the second electrolyte region.

In the first aspect of the present invention, the electrolyte layer is composed of the first electrolyte region, the second electrolyte region and the third electrolyte region. Therefore, each of the electrolyte regions can be individually given necessary characteristics therefor. For example, the first electrolyte region is a region provided on the dielectric layer. Therefore, it can be formed using a material that can increase the contact with the dielectric layer. On the other hand, the second electrolyte region is a region provided on the first electrolyte region and in contact with the cathode layer. Therefore, it can be formed using a material that can increase the contact with the cathode layer.

The third electrolyte region is formed in a portion of the capacitor element in which the cathode layer is not provided, and is provided in contact with the second electrolyte region or the first electrolyte region. In forming the resin outer package to cover the capacitor element, the portion of the capacitor element in which the cathode layer is present can reduce the stress on the interior of the capacitor element because of the presence of the cathode layer. On the other hand, the portion of the capacitor element in which the cathode layer is not present is susceptible to stress in forming the resin outer package, and the stress may increase the leakage current. According to the present invention, since the third electrolyte region is provided in the portion of the electrolyte layer on which the cathode layer is not provided and in a way to cover the second electrolyte region or the first electrolyte region, the stress in forming the resin outer package can be reduced and, therefore, the leakage current can be reduced.

In the first aspect of the present invention, an anode lead may be provided at a side surface of the anode with a part thereof embedded in the anode. Note that in the first aspect of the present invention, the “side surface” of the anode means a side surface of the outer shape of the anode. If the anode is formed of a porous body as described later, the outer shape of the anode refers to the outer shape where the presence of pores is discounted. The cathode layer is generally not formed over the side surface of the anode in which the anode lead is embedded. Therefore, in this case, the third electrolyte region is provided over the side surface of the anode.

If the anode lead is provided at the side surface of the anode to be embedded therein, the side surface is more susceptible to stress in forming the resin outer package. By providing the third electrolyte region according to the first aspect of the present invention, the stress in forming the resin outer package in this case can be further reduced and, therefore, the leakage current can be further reduced. According to the first aspect of the present invention, since the third electrolyte region having electric conductivity is provided on the second electrolyte region or the first electrolyte region, the leakage current can be reduced without increasing the ESR.

In the first aspect of the present invention, the hardness of each of the first and third electrolyte regions is preferably lower than that of the second electrolyte region. If the hardness of the first electrolyte region is lower than that of the second electrolyte region, the first electrolyte region provided on the dielectric layer can be made relatively soft. This increases the contact between the dielectric layer and the first electrolyte region. Therefore, the delamination between the dielectric layer and the electrolyte layer can be prevented or reduced. In addition, the stress through the electrolyte layer on the dielectric layer can be relieved, which reduces the capacitance reduction of the solid electrolyte capacitor held at high temperatures and reduces the increase in leakage current.

If the hardness of the third electrolyte region is lower than that of the second electrolyte region, the stress on the capacitor element in forming the resin outer package can be further reduced. This further reduces the increase in leakage current.

If the hardness of the second electrolyte region is relatively high, this increases the contact between the cathode layer and the second electrolyte region, thereby further reducing the ESR.

In the first aspect of the present invention, the thickness ratio of the third electrolyte region to the second electrolyte region (third electrolyte region thickness/second electrolyte region thickness) is preferably in the range of 0.1 to 10. If the thickness ratio is in the above range, the ESR can be further reduced and, therefore, the leakage current can be further reduced. In addition, the capacitance reduction of the solid electrolytic capacitor held at high temperatures can be further reduced.

Hence, according to the first aspect of the present invention, the leakage current of the solid electrolytic capacitor can be reduced without increasing the ESR.

### <Second Aspect of the Invention>

A solid electrolytic capacitor according to a second aspect of the present invention includes: an anode made of a valve metal or an alloy of a valve metal; a dielectric layer formed on the surface of the anode; an electrolyte layer formed on the dielectric layer; a cathode layer formed on the electrolyte layer; and a resin outer package covering a capacitor element composed of the anode, the dielectric layer, the electrolyte layer and the cathode layer, wherein the electrolyte layer is composed of a first electrolyte region provided on the dielectric layer, a second electrolyte region provided on the first electrolyte region and in contact with the cathode layer, and a third electrolyte region provided in contact with a portion of the second electrolyte region or the first electrolyte region on which the cathode layer is not provided, and linear expansion coefficients of the first, second and third electrolyte regions increase in the order named.

In the second aspect of the present invention, for example, the portion of the electrolyte layer on which the cathode layer is not provided may be composed of the first, second and third electrolyte regions formed in this order on the dielectric layer or may be composed of the first and third electrolyte regions formed in this order on the dielectric layer. In the second aspect of the present invention, like this, the portion of the electrolyte layer on which the cathode layer is not provided may not include the second electrolyte region.

In the second aspect of the present invention, the electrolyte layer is composed of the first electrolyte region, the second electrolyte region and the third electrolyte region, and the first, second and third electrolyte regions increase in linear expansion coefficient in the order named. The first electrolyte region having the lowest linear expansion coefficient is provided on the dielectric layer. The anode is generally made of a material having a smaller linear expansion coefficient than the cathode layer and the resin outer package. For example, the linear expansion coefficient of niobium is 7.1×10⁻⁶ (K⁻¹). The linear expansion coefficient of tantalum is 6.5×10⁻⁶ (K⁻¹). The linear expansion coefficients of carbon and silver used in the cathode layer are approximately 7×10⁻⁶ (K⁻¹) and approximately 19×10⁻⁶ (K⁻¹), respectively. However, because the particles forming each of these materials are bound together by a binder, the cathode layer can be considered to have a higher linear expansion coefficient. On the other hand, epoxy resin generally used in the resin outer package has a relatively high linear expansion coefficient of 40×10⁻⁶ (K⁻¹) to 80×10⁻⁶ (K⁻¹). In the second aspect of the present invention, the first electrolyte region provided on the dielectric layer of relatively low linear expansion coefficient has the lowest linear expansion coefficient. The second electrolyte region is provided on the first electrolyte region and in contact with the cathode layer. Specifically, the second electrolyte region is provided in contact with the cathode layer generally having a higher linear expansion coefficient than the anode. In the second aspect of the present invention, the linear expansion coefficient of the second electrolyte region is set to a higher value than that of the first electrolyte region to avoid that the difference in linear expansion coefficient from the cathode layer becomes large.

The third electrolyte region is formed in the portion of the electrolyte layer on which the cathode layer is not provided, and is provided in contact with the second electrolyte region or the first electrolyte region. In the portion of the electrolyte layer on which the cathode layer is present, the cathode layer is in contact with the resin outer package. On the other hand, in the portion of the electrolyte layer on which the cathode layer is not provided, the resin outer package is in contact with the electrolyte layer. In the second aspect of the present invention, the third electrolyte region is provided in the portion of the electrolyte layer on which the cathode layer is not provided, and the linear expansion coefficient of the third electrolyte region is higher than those of the first and second electrolyte regions. Therefore, the third electrolyte region having a linear expansion coefficient near to that of the resin outer package, which is generally the highest linear expansion coefficient in the solid electrolytic capacitor, can be provided in contact with the resin outer package. Thus, the difference in linear expansion coefficient between the materials in contact with each other can be made small. Hence, according to the second aspect of the present invention, the solid electrolytic capacitor can reduce the delamination between the materials and the formation of defects when it is exposed to high temperatures, which reduces the reduction in capacitance and the increases in ESR and leakage current. Thus, according to the present invention, the reliability of the solid electrolytic capacitor at high temperatures can be increased.

In the second aspect of the present invention, an anode lead may be provided at a side surface of the anode with a part thereof embedded in the anode. Note that in the second aspect of the present invention, the “side surface” of the anode means a side surface of the outer shape of the anode. If the anode is formed of a porous body as described later, the outer shape of the anode refers to the outer shape where the presence of pores is discounted. The cathode layer is generally not formed over the side surface of the anode in which the anode lead is embedded. Therefore, in this case, the third electrolyte region is provided over the side surface of the anode. In forming the resin outer package, the portion of the anode in which the anode lead is embedded is particularly susceptible to stress. Since the third electrolyte region is provided over the side surface of the anode, the stress in forming the resin outer package can be reduced, thereby further reducing the increase in leakage current.

In the second aspect of the present invention, the linear expansion coefficient of the first electrolyte region is preferably 10×10⁻⁶ (K⁻¹) or less. As described previously, the linear expansion coefficient of niobium is 7.1×10⁻⁶ (K⁻¹), and the linear expansion coefficient of tantalum is 6.5×10⁻⁶ (K⁻¹). Therefore, it is preferable that the first electrolyte region have a linear expansion coefficient near to those of the above anode materials. On the other hand, it is preferable that the linear expansion coefficient of the first electrolyte region be 5×10⁻⁶ (K⁻¹) or more.

In the second aspect of the present invention, the linear expansion coefficient of the second electrolyte region is preferably smaller than that of the cathode layer. Thus, the compatibility in linear expansion coefficient from the first electrolyte region to the cathode layer increases, which can prevent or reduce the delamination of the interface between the cathode layer and the second cathode layer and the delamination of the interface between the first and second electrolyte regions.

In the second aspect of the present invention, the linear expansion coefficient of the third electrolyte region is preferably smaller than that of the resin outer package.

Thus, the compatibility in linear expansion coefficient over the resin outer package, the third electrolyte region and the first or second electrolyte region increases, which can prevent or reduce the occurrence of delamination between these materials.

In the second aspect of the present invention, the linear expansion coefficient of the third electrolyte region is preferably in the range of 30×10⁻⁶ (K⁻¹) to 40×10⁻⁶ (K⁻¹). As described previously, since the linear expansion coefficient of epoxy resin generally used as a resin outer package is 40×10⁻⁶ (K⁻¹) to 80×10⁻⁶ (K⁻¹), it is preferable that the third electrolyte region have a linear expansion coefficient lower than this range.

In the second aspect of the present invention, the linear expansion coefficient of the second electrolyte region is preferably in the range of 10×10⁻⁶ (K⁻¹) to 30×10⁻⁶ (K⁻¹), and more preferably in the range of 12×10⁻⁶ (K⁻¹) to 25×10⁻⁶ (K⁻¹).

According to the second aspect of the present invention, deteriorations in capacitor characteristics due to a heat cycle test, such as reduction in capacitance, increase in ESR and increase in leakage current, can be reduced, whereby the reliability of the solid electrolytic capacitor at high temperatures can be increased.

### BRIEF DESCRIPTION OF THE DRAWINGS

FIG. 1 is a cross-sectional view showing a solid electrolytic capacitor of an embodiment according to first and second aspects of the present invention.

FIG. 2 is a perspective view showing an anode in the embodiment shown in FIG. 1.

FIG. 3 is a cross-sectional view taken along the line A-A in FIG. 1.

FIG. 4 is a cross-sectional view taken along the line B-B in FIG. 1.

FIG. 5 is a cross-sectional view taken along the line C-C in FIG. 1.

FIG. 6 is a cross-sectional view showing a capacitor element in the embodiment shown in FIG. 1.

FIG. 7 is a cross-sectional view showing a solid electrolytic capacitor of another embodiment according to the first and second aspects of the present invention.

FIG. 8 is a cross-sectional view showing a solid electrolytic capacitor of Comparative Example 1.

FIG. 9 is a cross-sectional view showing solid electrolytic capacitors of Comparative Examples 2 and 5 to 9.

FIG. 10 is a cross-sectional view showing a solid electrolytic capacitor of Comparative Example 3.

### DETAILED DESCRIPTION OF PREFERRED EMBODIMENTS

Hereinafter, the present invention will be described in more detail with reference to the following embodiments. However, the present invention is not at all limited by the following embodiments, and can be embodied in various other forms appropriately modified without changing the spirit of the invention. The term “on” used herein in explaining layered structures is not necessarily limited to “directly on”, but may also include “indirectly on”, i.e., interposition of another or other layers. For example, when it is stated that a second layer is formed on a first layer, another or other layers may be interposed between the first and second layers.

FIG. 1 is a cross-sectional view showing a solid electrolytic capacitor of an embodiment according to first and second aspects of the present invention.

As shown in FIG. 1, an anode lead 1 is provided at a side surface 2a of an anode 2 with a part thereof embedded in the anode 2. The anode 2 is formed of a porous body obtained by forming powder of a valve metal or a valve metal alloy into a formed body having the outer shape of an approximately rectangular box and then sintering the formed body in a vacuum. The porous body thus obtained has interconnected pores formed in sintered powder. The pores are open to the outside. Note that the pores in the porous body are not given in FIG. 1. Examples of the valve metal include niobium, tantalum, titanium and aluminium. Examples of the valve metal alloy include alloys containing the above metals as their main ingredients.

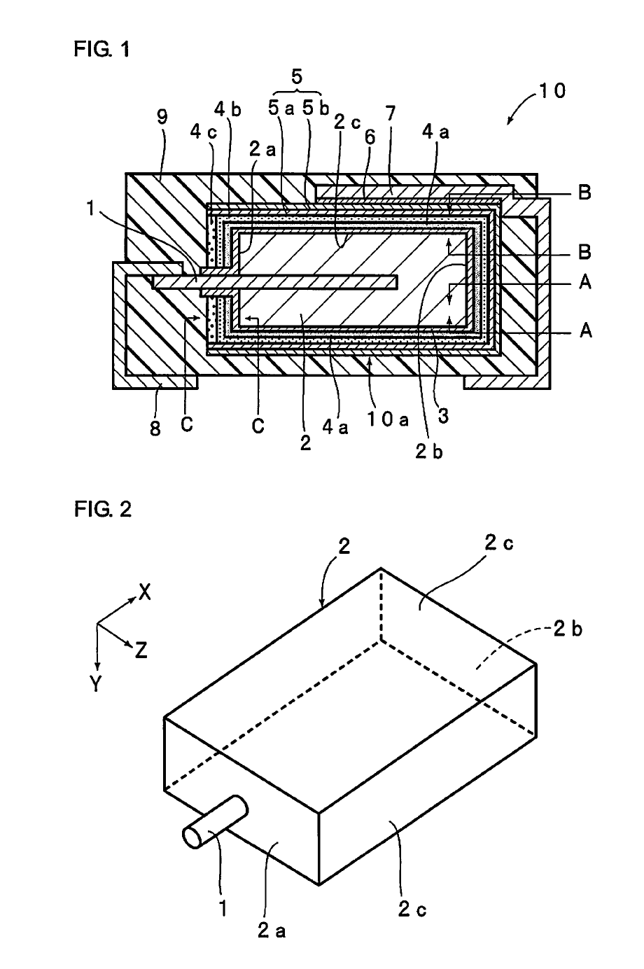

FIG. 2 is a perspective view showing the outer shape of the anode 2. As shown in FIG. 2, the anode 2 has the outer shape of an approximately rectangular box. The pores in the porous body are not given in this figure. As shown in FIGS. 1 and 2, the anode 2 has six outside surfaces: a side surface 2a in which the anode lead 1 is embedded, a side surface 2b opposite to the side surface 2a, and four outside surfaces 2c connecting the side surfaces 2a and 2b.

Referring back to FIG. 1, a dielectric layer 3 made mainly of an oxide is formed on the surface of the anode 2. The dielectric layer 3 is generally formed by anodizing the surface of the anode 2.

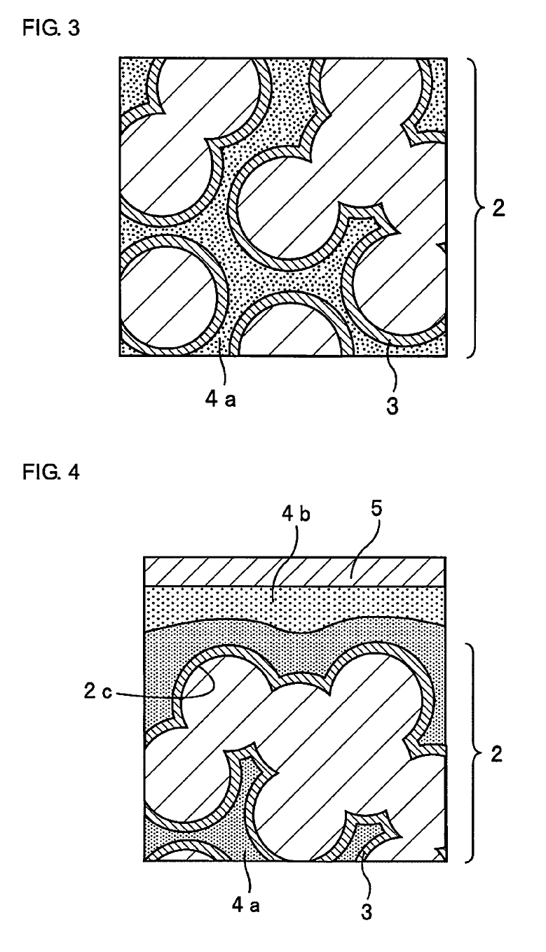

FIG. 3 is an enlarged schematic cross-sectional view taken along the line A-A in FIG. 1. As described previously, the anode 2 is made of a porous body and has fine pores formed to be open to the outside. As shown in FIG. 3, the dielectric layer 3 is formed on the surface of the anode 2. In addition, the dielectric layer 3 is also formed on part of the surface of the anode lead 1 partially embedded in the side surface 2a of the anode 2.

As also shown in FIG. 3, a first electrolyte region 4a is formed over the surface of the anode 2 to come into contact with the dielectric layer 3.

Referring again to FIG. 1, a second electrolyte region 4b is formed over the side surfaces 2a and 2b and outside surfaces 2c of the anode 2 and on the first electrolyte region 4a formed on the dielectric layer 3. Furthermore, a third electrolyte region 4c is formed over the side surface 2a of the anode 2 and on the second electrolyte region 4b.

A carbon layer 5a is formed over the side surface 2b and outside surfaces 2c of the anode 2 and on the second electrolyte region 4b lying on the first electrolyte region 4a formed on the dielectric layer 3. A silver layer 5b is formed on the carbon layer 5a. The carbon layer 5a and the silver layer 5b constitute a cathode layer 5. In this case, as shown in FIG. 1, the cathode layer 5 is not formed on the surface of the third electrolyte region 4c. Although in FIG. 1 the ends of the third electrolyte region 4c are in contact with the cathode layer 5, they need not necessarily be so and may be spaced apart from the cathode layer 5.

FIG. 4 is an enlarged schematic cross-sectional view taken along the line B-B in FIG. 1. As shown in FIG. 4, each outside surface 2c of the anode 2, which is one of the outside surfaces constituting the outer shape of the anode 2, is formed by sintered particles located on the outside of the anode 2. On a portion of the dielectric layer 3 formed on the outside surface 2c are formed the first electrolyte region 4a and the second electrolyte region 4b in the order named towards the cathode layer 5. As shown in FIG. 1, the first electrolyte region 4a and the second electrolyte region 4b are formed in the order named over the side surface 2b as well as over the outside surfaces 2c. Although in FIGS. 3 to 5 the pores in the anode 2 are filled with the first electrolyte region 4a, the present invention is not limited to this. If the pores in the anode 2 are not sufficiently filled with the first electrolyte region 4a and voids are left in the pores, the second electrolyte region 4b may be formed in the voids.

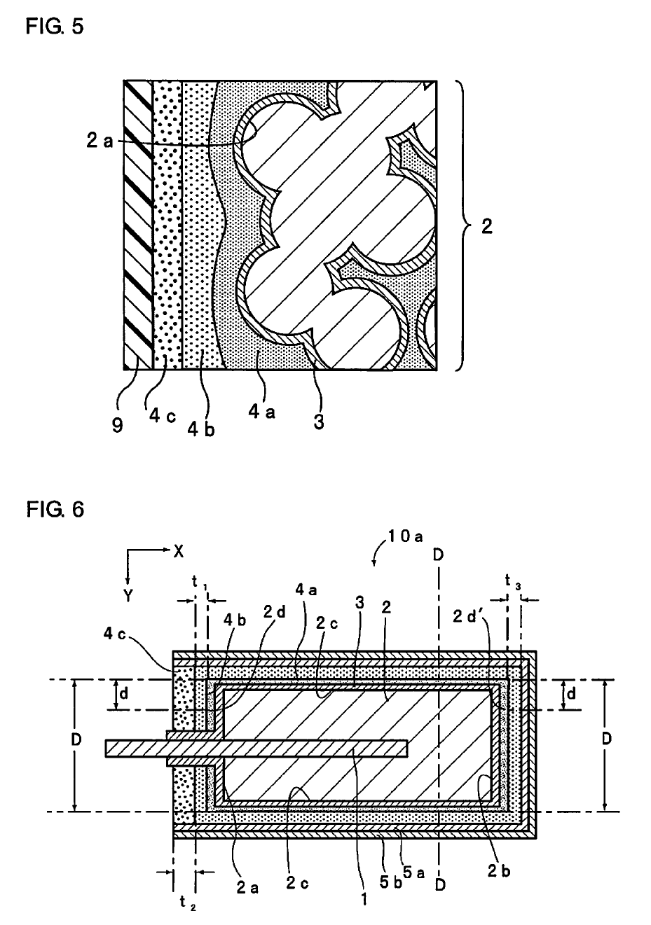

FIG. 5 is an enlarged schematic cross-sectional view taken along the line C-C in FIG. 1. As shown in FIG. 5, the side surface 2a of the anode 2, which is one of the outside surfaces constituting the outer shape of the anode 2, is formed by sintered particles located on the outside of the anode 2. Referring to FIG. 5, the first electrolyte region 4a and the second electrolyte region 4b are also formed on a portion of the dielectric layer 3 lying on the side surface 2a of the anode 2, and the third electrolyte region 4c is formed on the second electrolyte region 4b. Furthermore, a resin outer package 9 is formed on the third electrolyte region 4c. Therefore, on a portion of the dielectric layer 3 formed on the side surface 2a are formed the first electrolyte region 4a, the second electrolyte region 4b and the third electrolyte region 4c in the order named towards the resin outer package 9. Although in this embodiment the third electrolyte region 4c is formed on the second electrolyte region 4b, only the first electrolyte region 4a may be first formed on the portion of the dielectric layer 3 formed on the side surface 2a, followed by the formation of the third electrolyte region 4c on the first electrolyte region 4a. In this case, on the portion of the dielectric layer 3 formed on the side surface 2a are formed the first electrolyte region 4a and the third electrolyte region 4c in the order named towards the resin outer package 9.

In this embodiment, an electrolyte layer is constituted by the first electrolyte region 4a, the second electrolyte region 4b and the third electrolyte region 4c.

A capacitor element 10a is constituted by the anode 2, the anode lead 1, the dielectric layer 3, the electrolyte layer 4a, 4b and 4c, and the cathode layer 5. As shown in FIG. 1, a cathode terminal 7 is joined through a conductive adhesive layer 6 to the cathode layer 5 of the capacitor element 10a. An anode terminal 8 is joined to the anode lead 1 such as by welding. The resin outer package 9 is formed to cover the entire capacitor element 10a to which the cathode terminal 7 and the anode terminal 8 are joined. The resin outer package 9 is formed to expose the ends of the cathode and anode terminals 7 and 8.

The solid electrolytic capacitor 10 of this embodiment according to the first and second aspects of the present invention has the above structure.

In this embodiment, the third electrolyte region 4c is formed over the side surface 2a of the anode 2. Therefore, in forming the resin outer package 9 to cover the capacitor element 10a therewith, the stress on the capacitor element 10a can be reduced. In forming the resin outer package 9, the side surface 2a of the anode 2 provided with the anode lead 1 embedded therein is particularly susceptible to stress and the stress may increase the leakage current of the capacitor. Since the third electrolyte region 4c is provided to cover the side surface 2a of the anode 2, the stress in forming the resin outer package 9 can be reduced and, therefore, the leakage current can be reduced.

A portion of the capacitor element 10a in which the cathode layer 5 is not provided, i.e., a portion thereof located over the side surface 2a in this embodiment, is likely to be subject to the stress in forming the resin outer package 9. The stress may cause defects and the like in the dielectric layer and thereby increase the leakage current. Since in this embodiment the third electrolyte region 4c is formed over the side surface 2a in the portion of the capacitor element 10a in which the cathode layer 5 is not provided, the stress in forming the resin outer package 9 can be reduced, whereby the leakage current can be reduced. Although in this embodiment the third electrolyte region 4c covers the portion of the electrolyte layer on which the cathode layer 5 is not provided, it will suffice if the third electrolyte region 4c covers the portion to such an extent that can reduce the stress in forming the resin outer package 9.

The first, second and third electrolyte regions 4a, 4b and 4c can be made of a conducting polymer, such as polythiophene or polypyrrole. The first electrolyte region 4a can be formed, for example, by impregnating the anode 2 with a monomer solution for forming a conducting polymer and then polymerizing the monomer. The second electrolyte region 4b can be formed by attaching a monomer solution for a conducting polymer to the side surfaces 2a and 2b and outside surfaces 2c of the anode 2, on which the first electrolyte region 4a is formed, by dipping of the anode 2 in the monomer solution, and then polymerizing the monomer. Alternatively, the second electrolyte region 4b may be formed by attaching the monomer solution to the side surfaces 2a and 2b and outside surfaces 2c of the anode 2 by application, and then polymerizing the monomer.

The third electrolyte region 4c can be formed by applying a monomer solution for a conducting polymer to the side surface 2a of the anode 2 and then polymerizing the monomer. If the second electrolyte region 4b is not formed over the side surface 2a of the anode 2, the third electrolyte region 4c is formed over the side surface 2a of the anode 2 and on the first electrolyte region 4a. If the second electrolyte region 4b is formed over the side surface 2a of the anode 2, the third electrolyte region 4c is formed on that portion of the second electrolyte region 4b.

The carbon layer 5a can be formed by applying a carbon paste on a portion of the second electrolyte region 4b lying on the outside surfaces 2c of the anode 2 and then drying it.

The silver layer 5b can be formed by applying a silver paste to the carbon layer 5a and drying it.

The conductive adhesive layer 6 can be formed using a conductive paste.

The resin outer package 9 can be formed, following the joining of the cathode terminal 7 and the anode terminal 8 to the capacitor element 10a, by molding a resin, such as epoxy resin, around the capacitor element 10a.

In this embodiment, the electrolyte layer for electrically connecting the dielectric layer 3 with the cathode layer 5 is constituted by the first electrolyte region, the second electrolyte region and the third electrolyte region. Therefore, each of the electrolyte regions can be individually given necessary characteristics therefor.

When each of the first, second and third electrolyte regions is made of a conducting polymer, the type of the conducting polymer forming each electrolyte region, the polymerization process therefor and the additive therefor may be changed from region to region. For example, if an additive made of an organic material, such as resin, is incorporated into the conducting polymer, the hardness of the conducting polymer layer obtained can be changed.

### <First Aspect of the Invention>

In the first aspect of the present invention, the hardness of each of the first and third electrolyte regions 4a and 4c is preferably lower than that of the second electrolyte region 4b. Examples of a method for lowering the hardness of each of the first and third electrolyte regions 4a and 4c below the hardness of the second electrolyte region 4b include a method of incorporating, into a conducting polymer for forming the first and third electrolyte regions 4a and 4c, a resin having a higher elasticity than the conducting polymer as an additive. Examples of the resin include silicone resins, for example, elastomeric silicone resins.

By lowering the hardness of the first electrolyte region 4a below the hardness of the second electrolyte region 4b, the first electrolyte region 4a in contact with the dielectric layer 3 can be made relatively soft. This increases the contact between the dielectric layer 3 and the first electrolyte region 4a. Therefore, the delamination between the dielectric layer 3 and the electrolyte layer can be prevented or reduced. In addition, the stress through the electrolyte layer on the dielectric layer 3 can be relieved, which reduces the capacitance reduction of the solid electrolytic capacitor held at high temperatures and reduces the increase in leakage current.

On the other hand, by lowering the hardness of the third electrolyte region 4c below the hardness of the second electrolyte region 4b, the stress on the capacitor element 10a in forming the resin outer package 9 can be reduced. This further reduces the increase in leakage current.

In addition, by giving the second electrolyte region 4b a relatively high hardness, the contact between the cathode layer 5 and the second electrolyte region 4b can be increased, thereby further reducing the ESR.

In this embodiment, the thickness ratio of the third electrolyte region 4c to the second electrolyte region 4b (third electrolyte region thickness/second electrolyte region thickness) is preferably in the range of 0.1 to 10. If the thickness ratio is in the above range, the ESR can be further reduced and, therefore, the leakage current can be further reduced. In addition, the capacitance reduction of the solid electrolytic capacitor held at high temperatures can be further reduced.

FIG. 2 is, as described previously, a perspective view showing the outer shape of the anode 2 used in this embodiment. As shown in FIG. 2, the anode 2 has the outer shape of an approximately rectangular box. Out of the three dimensions X, Y and Z of the box shape, the dimension Y is the shortest. In the present invention, the direction along the shortest of the three dimensions of the box shape is defined as the thickness direction thereof.

FIG. 6 is a cross-sectional view of the capacitor element 10a when taken along the X-Y plane to include the anode lead. FIG. 6 is a part of the cross section of FIG. 1, corresponding to the capacitor element 10a. As shown in FIG. 6, the thickness t₂ of the third electrolyte region 4c is defined as the thickness thereof at a point 2d a distance d closer to the center of the anode 2 than one of the opposed outside surfaces 2c and 2c of the anode 2 in the thickness direction Y of the anode 2, where the distance d corresponds to one-quarter of the distance D between the above opposed outside surfaces 2c and 2c.

If the second electrolyte region 4b is formed over the side surface 2a of the anode 2, the thickness of the second electrolyte region 4b refers to the thickness t₁ of a portion thereof lying over the side surface 2a of the anode 2. The thickness t₁ of the second electrolyte region 4b is also a value measured at the point 2d of the side surface 2a of the anode 2.

If the second electrolyte region 4b is not formed over the side surface 2a of the anode 2, the thickness of the second electrolyte region 4b refers to the thickness t₃ of a portion thereof formed over the side surface 2b of the anode 2 opposite to the side surface 2a. The thickness t₃ is a thickness measured at a point 2d′ of the side surface 2b corresponding to the point 2d of the side surface 2a.

The thickness ratio between the electrolyte regions can be suitably controlled by changing the polymerization time period and the like in forming the conducting polymer.

This embodiment employs, as described above, the anode 2 having the shape of an approximately rectangular box. If the anode 2 instead has a different shape, lines D-D normal to the outside surfaces 2c of the anode 2, one for each outside surface 2c, are assumed as shown in FIG. 6. Thus, the direction along the shortest of distances between intersection points of the normal lines D-D with opposed outside surfaces 2c can be defined as the thickness direction. With reference to the thickness direction can be measured the thickness of the second electrolyte region 4b and the thickness of the third electrolyte region 4c.

### <Second Aspect of the Invention>

In the second aspect of the present invention, the first, second and third electrolyte regions 4a, 4b and 4c increase in linear expansion coefficient in the order named. When each of these electrolyte regions is made of a conducting polymer, their linear expansion coefficients can be made different from region to region by changing the type of the conducting polymer forming each electrolyte region, the polymerization process therefor and the additive therefor. For example, if fine particles having a different linear expansion coefficient from the conducting polymer are mixed as an additive into the conducting polymer, the conducting polymer containing the fine particles can have a different linear expansion coefficient.

If the linear expansion coefficient of the conducting polymer is desired to be lowered, an additive made of a material with a negative linear expansion coefficient or a material with a lower linear expansion coefficient than the conducting polymer to be formed can be mixed into the conducting polymer. Examples of the material with a negative linear expansion coefficient include copper-germanium-manganese nitride (Mn₃(Cu_{0.5}Ge_{0.5})N), zirconium tungstate (ZrW₂O₈), and beta-eucryptite (Li₂O.Al₂O₃.2SiO₂).

Examples of the material with a relatively low linear expansion coefficient include, as elements, chromium, silicon, germanium, zirconium, tungsten and molybdenum, and include, as alloys, Invar alloys. Furthermore, oxides, such as silica, and nitrides, such as silicon nitride, can also be used as materials with a low linear expansion coefficient.

Examples of high-linear expansion coefficient materials usable are silicone resins, urethane resins, and fluorine-based resins.

The additive for controlling the linear expansion coefficient can be used, generally, in the form of fine particles. Fine particles preferably used are, for example, those having an average particle diameter ranging from 0.01 to 1 μm. If the additive can be dissolved in the monomer solution for forming the conducting polymer, it may be used in that manner.

In the second aspect of the present invention, the electrolyte layer is separated into the first, second and third electrolyte regions, and the electrolyte regions are set to stepwise increase in linear expansion coefficient as they approach the resin outer package outside the anode from the anode inside. Therefore, when the solid electrolytic capacitor is heated in a heat cycle test, the components constituting the solid electrolytic capacitor can be inhibited from producing strain due to differences in linear expansion coefficient between the components, whereby deteriorations in capacitor characteristics, such as reduction in capacitance, increase in ESR and increase in leakage current, can be reduced.

In the second aspect of the present invention, the linear expansion coefficient of each of the first, second and third electrolyte regions may not be constant in the thickness direction of the electrolyte region. For example, the electrolyte layer may have a structure in which the linear expansion coefficient gradually increases in each of the electrolyte regions in order of the first electrolyte region 4a, the second electrolyte region 4b and the third electrolyte region 4c.

### EXAMPLES

Hereinafter, the present invention will be described with reference to more concrete examples. However, the present invention is not limited to the following examples.

### First Aspect of the Invention

### Experiment 1

### Example 1

A solid electrolytic capacitor shown in FIG. 1 was produced in the following manner.

### (Step 1)

Using niobium metal powder having an average primary particle diameter of approximately 0.5 μm, a formed body was formed to embed part of an anode lead into it. The formed body was sintered in a vacuum to form an anode 2 made of a porous niobium sinter whose X-axis dimension shown in FIG. 2 is approximately 4.4 mm, whose Z-axis dimension is approximately 3.3 mm and whose Y-axis dimension is approximately 1.0 mm.

A lead made of niobium (diameter: 0.5 mm) was used as the anode lead 1.

### (Step 2)

The anode was anodized at a constant voltage of approximately 10 V for approximately 10 hours in approximately 0.01% by weight of aqueous solution of phosphoric acid kept at approximately 60° C., thereby forming a dielectric layer 3 on the surface of the anode 2.

### (Step 3)

The anode 2 having the dielectric layer 3 formed thereon was dipped into a solution of oxidizing agent, and then dipped into a pyrrole monomer solution containing 1.0% by weight of silicone resin (Trade name: TOSPEARL 120, made by Momentive Performance Materials Inc.). Thus, on the surface of the dielectric layer 3 was formed by chemical polymerization a conducting polymer layer made of polypyrrole containing silicone resin. The obtained conducting polymer layer constitutes the first electrolyte region 4a.

<Measurement of Hardness of First Electrolyte Region 4a>

A conducting polymer was prepared, as with the first electrolyte region 4a, by using a pyrrole monomer solution containing a silicone resin to polymerize the monomer, milled and then molded into a plate-shaped molded material with 8 mm thickness. A test specimen with 30 mm width and 30 mm length was cut out of the molded material, and measured in terms of Shore hardness with a desk-top durometer (Type D) according to JIS-K7215. The measurement was made, using the calculation formula for the hardness, based on the depth (h) of penetration of the indenter into the specimen when a specified load is placed on the indenter. The measured Shore hardness of the first electrolyte region 4a was 50.

### (Step 4)

After the formation of the first electrolyte region 4a, the anode 2 was dipped into a pyrrole monomer solution, and in this state a conducting polymer made of polypyrrole was produced by electrolytic polymerization, thereby forming a second electrolyte region 4b on the anode 2. The pyrrole monomer solution used in this case was a solution containing no silicone resin. The above solution was used to prepare a conducting polymer for forming a second electrolyte region and, in the same manner as described above, a test specimen for the second electrolyte region was measured in terms of Shore hardness. The measured Shore hardness of the second electrolyte region 4b was 95.

The second electrolyte region 4b was, as shown in FIG. 1, formed on the side surface 2a of the anode 2. By dipping the anode 2 into the pyrrole monomer solution so that the side surface 2a of the anode 2 is located below the liquid level of the solution, the second electrolyte region 4b can be formed on the side surface 2a of the anode 2.

### (Step 5)

Next, a solution of oxidizing agent was applied on a portion of the second electrolyte region 4b lying on the side surface 2a of the anode 2, and then a pyrrole monomer solution containing 1.2% by weight of the same silicone resin as used in Step 3 was also applied on the portion of the second electrolyte region 4b. Thus, a third electrolyte region 4c was formed by chemical polymerization on that portion of the second electrolyte region 4b lying on the side surface 2a of the anode 2.

The third electrolyte region 4c was measured in terms of Shore hardness in the same manner as described above. The measured Shore hardness was 40.

The ratio of the thickness t₂ of the third electrolyte region 4c to the thickness t₁ of the second electrolyte region 4b defined as described previously was 1.0. The thickness t₁ of the second electrolyte region 4b and the thickness t₂ of the third electrolyte region 4c can be measured by monitoring a cross section of the capacitor element with a scanning electron microscope (SEM).

The method for forming the third electrolyte region 4c is not limited to the above method. For example, a conducting polymer layer made of silicone resin-containing polypyrrole can be formed by applying a paste to a surface of the anode 2 on which the third electrolyte region 4c is not desired to be formed (for example, one of the outside surfaces other than the side surface 2a) to mask the surface, dipping the anode 2 into a solution of oxidizing agent, and then dipping the anode 2 into a pyrrole monomer solution containing a predetermined amount of silicone resin to induce chemical polymerization. In this case, after the formation of the third electrolyte region 4c, the resist can be removed such as by ultrasonically washing the anode 2 in acetone.

In the present invention, the third electrolyte region 4c may be formed on a portion of the anode 2 other than the side surface 2a. For example, the third electrolyte region may be formed over the side surface 2a and the outside surfaces 2c of the anode 2.

### (Step 6)

Next, a carbon paste was applied on a portion of the second electrolyte region 4b lying on the outside surfaces 2c and the side surface 2b to cover the portion, followed by drying. Thus, a carbon layer 5a was formed. Next, a silver paste was applied on the carbon layer 5a, followed by drying. Thus, a silver layer 5b was formed.

Next, a cathode terminal 7 was joined through a conductive adhesive layer 6 onto the silver layer 5b, and an anode terminal 8 was welded to the anode lead 1, whereby the terminals were electrically connected to the capacitor element 10a.

### (Step 7)

Next, a resin outer package 9 was formed by transfer molding using a resin composition containing an epoxy resin as a main ingredient to cover the capacitor element 10a and expose the ends of the cathode and anode terminals 7 and 8.

In the above manner, a solid electrolytic capacitor 10 according to this example was produced.

### Example 2

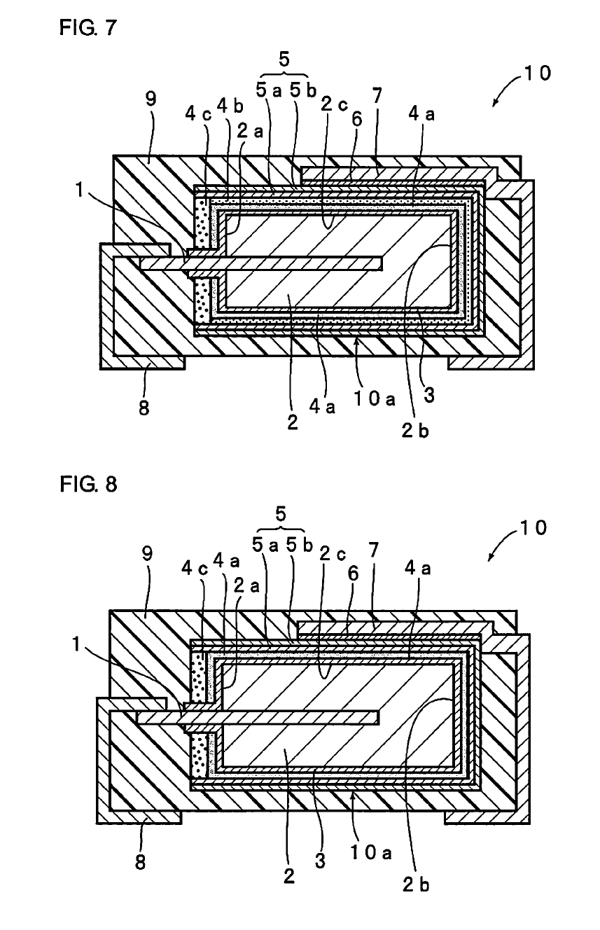

FIG. 7 is a cross-sectional view showing a solid electrolytic capacitor according to another embodiment. As shown in FIG. 7, in this embodiment, the second electrolyte region 4b is not formed over the side surface 2a of the anode 2, but the third electrolyte region 4c is formed over the side surface 2a of the anode 2 and on the first electrolyte region 4a.

The solid electrolytic capacitor of this example was produced by dipping the anode 2 into a pyrrole monomer solution in Step 4 of Example 1 so that the liquid level of the monomer solution is not above the side surface 2a of the anode 2.

### Comparative Example 1

FIG. 8 is a cross-sectional view showing a solid electrolytic capacitor of Comparative Example 1. In Comparative Example 1, Step 4 of Example 1 was not carried out, whereby no second electrolyte region 4b was formed. A solid electrolytic capacitor was produced in the same manner as in Example 1 except for the above point.

### Comparative Example 2

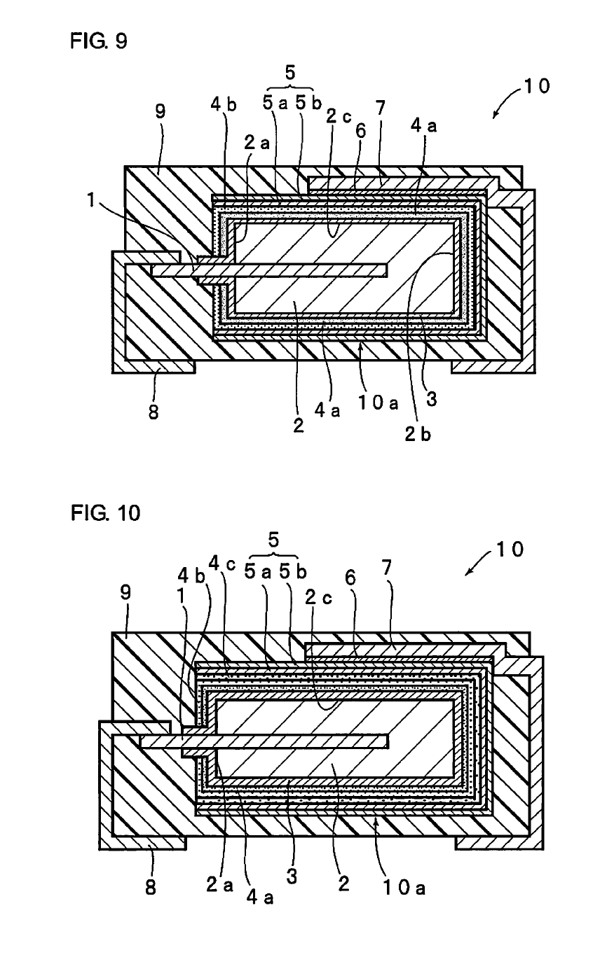

FIG. 9 is a cross-sectional view showing a solid electrolytic capacitor according to Comparative Example 2. In Comparative Example 2, Step 5 of Example 1 was not carried out, whereby no third electrolyte region 4c was formed. A solid electrolytic capacitor was produced in the same manner as in Example 1 except for the above point.

### Comparative Example 3

FIG. 10 is a cross-sectional view showing a solid electrolytic capacitor according to Comparative Example 3. In Comparative Example 3, the third electrolyte region 4c was formed, instead of being formed over the side surface 2a of the anode 2 and on the second electrolyte region 4b in Step 1 of Example 1, over the outside surfaces 2b and 2c of the anode 2 other than the side surface 2a and on the second electrolyte region 4b. A solid electrolytic capacitor was produced in the same manner as in Example 1 except for the above point.

### Comparative Example 4

Instead of the formation of the third electrolyte region 4c in Step 5 of Example 1, a silicone resin layer was formed, using an insulating silicone resin (Trade Name: TSE3250, made by Momentive Performance Materials Inc.), in that portion of the capacitor element where the third electrolyte region 4c would otherwise be formed. In this case, the ratio of the thickness t₂ of the silicone resin layer to the thickness t₁ of the second electrolyte region 4b was 1.0 like Example 1.

### <Measurement of Leakage Current>

A voltage of 2.5 V was applied to each of the solid electrolytic capacitors of Examples 1 and 2 and Comparative Examples 1 to 4, and a current flowing through the capacitor after five minutes was measured as a leakage current. The measurement results are shown in Table 1.

### <Measurement of ESR>

Each of the solid electrolytic capacitors of Examples and 2 and Comparative Examples 1 to 4 was measured in terms of ESR at 100 kHz. The measurement results are shown in Table 1.

### <Evaluation of Capacitance Retention in Long-Term Reliability Test>

Each of the solid electrolytic capacitors of Examples 1 and 2 and Comparative Examples 1 to 4 was subjected to a high-temperature load test (reliability test) by applying a voltage of 2.5 V to the capacitor in an atmosphere at 105° C. The high-temperature load test was conducted for 1000 hours. The capacitances of each capacitor at a frequency of 120 Hz before and after the test were measured with an LCR meter, and the percentage of capacitance retention of the capacitor was calculated according to the following equation. A percentage of capacitance retention closer to 100 indicates that the capacitance was less deteriorated by the reliability test.

Percentage of capacitance retention={(capacitance after reliability test)/(capacitance before reliability test)}×100

The measurement results are shown in Table 1.

TABLE 1

| | Leakage | | |
|---|---|---|---|
| | Current | ESR | Capacitance |
| | (μA) | (mΩ) | Retention (%) |
| Ex. 1 | 20 | 10 | 97 |
| Ex. 2 | 23 | 10 | 97 |
| Comp. Ex. 1 | 2851 | 45 | 55 |
| Comp. Ex. 2 | 3267 | 17 | 46 |
| Comp. Ex. 3 | 3380 | 55 | 53 |
| Comp. Ex. 4 | 1935 | 18 | 45 |

As shown in Table 1, the solid electrolytic capacitors of Examples 1 and 2 according to the present invention exhibited low leakage currents, low ESRs, and high capacitance retentions.

Comparative Example 1, in which no second electrolyte region 4b was formed, exhibited a high leakage current, a high ESR, and a low capacitance retention. Particularly, its leakage current was very high. We believe this is because the provision of the second electrolyte region 4b offered an excellent contact with the carbon layer 5a and silver layer 5b formed thereon, and allowed reduction of stress on the anode 2 and in turn reduction of the leakage current.

Comparative Example 2, in which no third electrolyte region 4c was formed, exhibited a particularly high leakage current. We believe this is because, in molding the resin outer package 9, the provision of the third electrolyte region 4c over the side surface 2a of the anode 2 highly susceptible to stress allowed reduction of stress and in turn reduction of the increase in leakage current.

Also Comparative Example 3, in which the third electrolyte region 4c was formed not over the side surface 2a of the anode 2 but over the other surfaces thereof, exhibited a significantly high leakage current. This also shows that the provision of the third electrolyte region 4c allows reduction of stress in resin molding and in turn reduction of the increase in leakage current.

Comparative Example 4, in which a silicone resin layer was formed instead of the third electrolyte region 4c, reduced the increase in leakage current as compared with Comparative Example 2. We believe this is because the provision of the silicone resin layer over the side surface 2a of the anode 2 allowed reduction of stress in resin molding. However, Comparative Example 4 exhibited a higher ESR than Examples 1 and 2. We believe this is because the silicone resin layer had no conductivity and, therefore, could not sufficiently reduce the ESR.

As described so far, the solid electrolytic capacitors of Examples 1 and 2 according to the present invention exhibited low leakage currents, low ESRs, and high capacitance retentions. We believe this is because the first electrolyte region 4a could mainly reduce the delamination between the dielectric layer 3 and the electrolyte layer in the long-term reliability test, the second electrolyte region 4b could mainly reduce the interface resistance with the cathode layer 5, and the third electrolyte region 4c could mainly reduce the stress on the capacitor element in forming the resin outer package.

### Experiment 2

### Example 3

A solid electrolytic capacitor was produced in the same manner as in Example 1 except for the use of a pyrrole monomer solution containing 1.0% by weight of silicone resin in Step 5 of Example 1.

The Shore hardness of a third electrolyte region 4c produced in this example was 50.

### Example 4

A solid electrolytic capacitor was produced in the same manner as in Example 1 except for the use of a pyrrole monomer solution containing 0.8% by weight of silicone resin in Step 5 of Example 1.

The Shore hardness of a third electrolyte region 4c produced in this example was 60.

### Example 5

A solid electrolytic capacitor was produced in the same manner as in Example 1 except that in Step 3 of Example 1a first electrolyte region 4a was formed using a pyrrole monomer solution containing no silicone resin, and that in Step 4 a second electrolyte region 4b was formed by dipping the anode 2 into a pyrrole monomer solution containing 1.0% by weight of silicone resin and electrolytically polymerizing the monomer.

The Shore hardnesses of the first and second electrolyte regions 4a and 4b formed in this example were 80 and 30, respectively.

### Example 6

A solid electrolytic capacitor was produced in the same manner as in Example 1 except that in Step 3 of Example 1a first electrolyte region 4a was formed using a pyrrole monomer solution containing 1.2% by weight of silicone resin, that in Step 4 a second electrolyte region 4b was formed by dipping the anode 2 into a pyrrole monomer solution containing 1.0% by weight of silicone resin and electrolytically polymerizing the monomer, and that in Step 5 a third electrolyte region 4c was formed using a pyrrole monomer solution containing no silicone resin.

The Shore hardnesses of the first, second and third electrolyte regions 4a, 4b and 4c formed in this example were 40, 30 and 80, respectively.

### <Evaluation of Characteristics of Solid Electrolytic Capacitors>

The leakage currents, ESRs and capacitance retentions of the solid electrolytic capacitors of the above examples were measured in the same manner as described previously.

The measurement results are shown in Table 2.

TABLE 2

| | Shore Hardness of Each Electrolyte Region | | | | | |
|---|---|---|---|---|---|---|
| | First | Second | Third | Leakage | | |
| | Electrolyte | Electrolyte | Electrolyte | Current | ESR | Capacitance |
| | Region | Region | Region | (μA) | (mΩ) | Retention (%) |
| Example 1 | 50 | 95 | 40 | 20 | 10 | 97 |
| Example 3 | 50 | 95 | 50 | 25 | 11 | 96 |
| Example 4 | 50 | 95 | 60 | 32 | 11 | 96 |
| Example 5 | 80 | 30 | 40 | 95 | 29 | 80 |
| Example 6 | 40 | 30 | 80 | 145 | 22 | 87 |

Table 2 shows that Examples 1, 3 and 4, in which the Shore hardnesses of the first and third electrolyte regions 4a and 4c are lower than that of the second electrolyte region 4b, exhibited particularly low leakage currents and ESRs and high capacitance retentions. We believe one reason for this is that since the first electrolyte region 4a was softer than the second electrolyte region 4b, this further increased the contact between the dielectric layer 3 and the electrolyte layer to reduce the delamination between the dielectric layer 3 and the electrolyte layer and relieve the stress through the electrolyte layer on the dielectric layer 3, whereby the capacitance reduction of the solid electrolytic capacitor held at high temperatures and the increase in leakage current could be further effectively reduced.

Another reason is that since the third electrolyte region 4c was softer than the second electrolyte region 4b, the stress on the capacitor element 10a in forming the resin outer package 9 could be reduced, thereby further effectively reducing the increase in leakage current.

Still another reason is that since the second electrolyte region 4b was relatively hard, this increased the contact between the cathode layer 5 and the electrolyte layer, thereby further reducing the ESR.

In Examples 5 and 6, the hardnesses of the first and third electrolyte regions 4a and 4c were higher than that of the second electrolyte region 4b. Therefore, as compared to Examples 1, 3 and 4, Examples 5 and 6 had smaller effects on the reduction of leakage current and ESR and exhibited lower capacitance retentions. However, as compared to Comparative Examples 1 to 4 shown in Table 1, Examples 5 and 6 exhibited high capacitance retentions, low leakage currents and low ESRs, and had excellent long-term reliability.

### Experiment 3

### Examples 7 to 19

Solid electrolytic capacitors were produced in the same manner as in Example 1 except that their ratios of the thickness t₂ of the third electrolyte region 4c to the thickness t₁ of the second electrolyte region 4b were set at 0.05, 0.08, 0.10, 0.20, 0.50, 0.80, 1.50, 2.00, 3.00, 5.00, 10.00, 11.00 and 14.00. The thickness t1 of the second electrolyte region 4b was controlled by controlling the dipping depth of the side surface 2a of the anode 2 into a pyrrole monomer solution and the polymerization time period in Step 4 of Example 1. The thickness t₂ of the third electrolyte region 4c was controlled by controlling the application thickness of a pyrrole monomer solution to a portion of the second electrolyte region 4b lying on the side surface 2a of the anode 2 and the polymerization time period. When a large application thickness was required, the application was repeated plural times.

The leakage currents, ESRs and capacitance retentions of the solid electrolytic capacitors of the above examples were measured in the same manner as described previously. The measurement results are shown in Table 3.

TABLE 3

| | Third Electrolyte | | | |
|---|---|---|---|---|
| | Region Thickness/ | Leakage | | |
| | Second Electrolyte | Current | ESR | Capacitance |
| | Region Thickness | (μA) | (mΩ) | Retention (%) |
| Example 7 | 0.05 | 114 | 15 | 80 |
| Example 8 | 0.08 | 105 | 12 | 82 |
| Example 9 | 0.10 | 56 | 11 | 90 |
| Example 10 | 0.20 | 48 | 10 | 92 |
| Example 11 | 0.50 | 35 | 10 | 95 |
| Example 12 | 0.80 | 33 | 11 | 97 |
| Example 1 | 1.00 | 20 | 10 | 97 |
| Example 13 | 1.50 | 18 | 12 | 95 |
| Example 14 | 2.00 | 20 | 14 | 93 |
| Example 15 | 3.00 | 45 | 18 | 89 |
| Example 16 | 5.00 | 68 | 18 | 89 |
| Example 17 | 10.00 | 75 | 22 | 88 |
| Example 18 | 11.00 | 110 | 28 | 84 |
| Example 19 | 14.00 | 135 | 29 | 82 |

The results shown in Table 3 reveals that Examples 9 to 17, in which the ratio of the thickness t₂ of the third electrolyte region 4c to the thickness t₁ of the second electrolyte region 4b (Third Electrolyte Region Thickness/Second Electrolyte Region Thickness) was in the range of 0.1 to 10, had low leakage currents, low ESRs and particularly high capacitance retentions after subjected to the long-term reliability test.

The results shown in Table 3 also reveals that when the ratio of the thickness t₂ of the third electrolyte region 4c to the thickness t₁ of the second electrolyte region 4b is in the range of 0.5 to 2.0, the leakage current and ESR can be more effectively reduced, and the capacitance retention can be more effectively increased.

### Second Aspect of the Invention

### Preliminary Experiment

Next will be described a method for measuring the linear expansion coefficient of a conducting polymer used as a material for forming an electrolyte region in the following examples.

### <Case of Reducing the Linear Expansion Coefficient>

The linear expansion coefficient of polypyrrole serving as a conducting polymer is approximately 30×10⁻⁶ (K⁻¹). To reduce the linear expansion coefficient of the conducting polymer, fine particles (average particle diameter of approximately 0.1 μm) of copper-germanium-manganese nitride (Mn₃(Cu_{0.5}Ge_{0.5})N) were prepared, and an appropriate amount of the fine particles were mixed into the conducting polymer to control the linear expansion coefficient of the conducting polymer to a desired value. The linear expansion coefficient of the copper-germanium-manganese nitride used in this case was −11.5×10⁻⁶ (K⁻¹).

First, 150 mg of copper-germanium-manganese nitride particulate powder and 2 g of iron(III) p-toluenesulfonate serving as a source of an oxidizing agent and a dopant were homogeneously mixed into 100 g of ethanol solution containing 1% by weight of pyrrole serving as a polymerizable monomer, thereby preparing a chemically polymerizable liquid. Into the chemically polymerizable liquid was dipped an anode on which a dielectric layer was formed, whereby the chemically polymerizable liquid was attached to the surface of the anode. Then, the anode was allowed to stand at a room temperature (25° C.) to promote polymerization reaction, whereby a conducting polymer film made of polypyrrole was formed on the surface of the dielectric layer of the anode. Note that in this case the anode was used as a support for attaching the chemically polymerizable liquid thereto and polymerizing it. The conducting polymer film thus formed was peeled off from the surface of the dielectric layer and ground into powder. The powdered conducting polymer was pressed into specimens for measuring the linear expansion coefficient. The specimens were designated Analysis Samples S1.

The linear expansion coefficient was measured by subjecting the specimens to thermo-mechanical analysis (TMA). Specifically, the specimens were heated from 50° C. to 100° C. at a rate of 5° C./min in an air atmosphere with a measuring load of 2 g applied thereto, and the changes in length of the specimens during the heating time were measured. The linear expansion coefficient was calculated from each of the measured values according to the following equation (1). The average value of the linear expansion coefficients of three specimens was employed as the linear expansion coefficient of Analysis Sample S1.

Linear Expansion Coefficient=ΔL/(L×ΔT) (1)

where L indicates the length of the specimen at 50° C., ΔL indicates the difference between the length of the specimen at 50° C. and the length thereof at 100° C., and ΔT indicates the temperature difference (50° C.) between 50° C. and 100° C.

The linear expansion coefficient of Analysis Sample S1 determined in the above manner was approximately 20×10⁻⁶ (K⁻¹).

### <Case of Increasing the Linear Expansion Coefficient>

To increase the linear expansion coefficient of a conducting polymer, fine particles of a silicone resin having a large linear expansion coefficient (Trade Name: TSE3250, made by Momentive Performance Materials Inc.) were prepared, and an appropriate amount of the silicone resin fine particles were mixed into the conducting polymer to control the linear expansion coefficient of the conducting polymer to a desired value. The linear expansion coefficient of silicone resin used in this case was 250×10⁻⁶ (K⁻¹).

First, 25 mg of silicone resin particulate powder and 2 g of iron(III) p-toluenesulfonate serving as a source of an oxidizing agent and a dopant were homogeneously mixed into 100 g of ethanol solution containing 1% by weight of pyrrole serving as a polymerizable monomer, thereby preparing a chemically polymerizable liquid. The chemically polymerizable liquid was used to form a conducting polymer film made of polypyrrole on a dielectric layer of an anode, in the same manner as described previously, by attaching the chemically polymerizable liquid to the surface of the dielectric layer of the anode and allowing the anode to stand at a room temperature (25° C.) to promote polymerization reaction. The conducting polymer film thus formed was peeled off from the dielectric layer of the anode. The specimens obtained in the same manner as described previously were designated Analysis Samples S2.

The linear expansion coefficient of Analysis Sample S2 determined in the same manner as described previously was approximately 40×10⁻⁶ (K⁻¹).

### [Production of Solid Electrolytic Capacitor]

In the following Examples and Comparative Examples, as described in connection with the above preliminary experiment, the linear expansion coefficients of the first, second and third electrolyte regions were controlled depending on the type and amount of fine particles contained in the conducting polymer layer.

### Example 20 and Comparative Examples 5 to 11

### Example 20

A solid electrolytic capacitor shown in FIG. 1 was produced in the following manner.

### (Step 1)

There was prepared niobium metal powder having a CV value of 100, 000 μF·V/g. The niobium metal powder was formed into a formed body having the shape of an approximately rectangular box (size: 4.5 mm×3.3 mm×1.0 mm) to embed part of an anode lead therein. The formed body was sintered in a vacuum to produce an anode made of a porous body. The linear expansion coefficient of the anode was 7.1×10⁻⁶ (K⁻¹).

### (Step 2)

The anode was anodized at a constant voltage of 10 V for approximately 10 hours in approximately 0.01% by weight of aqueous solution of phosphoric acid kept at approximately 60° C. Thus, a dielectric layer made of niobium pentoxide was formed on the surface of the anode.

### (Step 3)

Next, in order to obtain a conducting polymer having a desired linear expansion coefficient, copper-germanium-manganese nitride particulate powder or silicone resin fine particles were added to an ethanol solution containing 1% by weight of pyrrole serving as a polymerizable monomer, followed by mixing. The mixture was homogeneously mixed with iron(III) p-toluenesulfonate serving as a source of an oxidizing agent and a dopant, thereby preparing a chemically polymerizable liquid. In this example, the chemically polymerizable liquid was prepared to provide a conducting polymer having a linear expansion coefficient of 7×10⁻⁶ (K⁻¹). For this purpose, copper-germanium-manganese nitride particulate powder was used as a powdered additive. The amount of additive necessary to achieve the desired linear expansion coefficient can be obtained by conducting the same experiment as the preliminary experiment while changing the amount of additive.

With the chemically polymerizable liquid thus prepared was impregnated the anode on which the dielectric layer was formed, and the anode was allowed to stand at a room temperature (25° C.) to promote polymerization reaction, whereby a conducting polymer film made of polypyrrole was formed on the dielectric layer of the anode. The obtained conducting polymer film constitutes a first electrolyte region 4a.

### (Step 4)

Next, a chemically polymerizable liquid was prepared to provide a second electrolyte region 4b having a desired linear expansion coefficient, and the chemical polymerization liquid was used to form the second electrolyte region 4b on the first electrolyte region 4a. Specifically, into the chemically polymerizable liquid was dipped the anode on which the first electrolyte region 4a was formed, thereby attaching the chemically polymerizable liquid to the anode. Then, the chemically polymerizable liquid was polymerized to form a second electrolyte region 4b. The thickness of a portion of the second electrolyte region 4b lying on the outside surfaces 2c of the anode 2 was approximately 50 μm. The linear expansion coefficient of the second electrolyte region 4b was controlled to reach 15×10⁻⁶ (K⁻¹) using copper-germanium-manganese nitride as an additive.

### (Step 5)

Next, a third electrolyte region 4c was formed over the side surface 2a of the anode 2 and on the second electrolyte region 4b. Specifically, a resist film was coated on the second electrolyte region 4b, except for a portion of the second electrolyte region 4b lying over the side surface 2a of the anode 2. Then, the anode partially coated with the resist film was dipped into a chemically polymerizable liquid, thereby forming a third electrolyte region 4c. The chemically polymerizable liquid was prepared to provide a third electrolyte region 4c having a linear expansion coefficient of 30×10⁻⁶ (K⁻¹). In other words, without adding any additive to a pyrrole monomer solution, a conducting polymer layer made only of polypyrrole was formed. Note that the third electrolyte region 4c was formed to have a thickness of approximately 50 μm.

### (Step 6)

Next, a carbon paste was applied on a portion of the second electrolyte region 4b lying on the outside surfaces 2b and 2c of the anode 2 other than the side surface 2a to cover the portion, followed by drying. Thus, a carbon layer 5a was formed. Next, a silver paste was applied on the carbon layer 5a, followed by drying. Thus, a silver layer 5b was formed. The linear expansion coefficients of the carbon layer 5a and the silver layer 5b were 8×10⁻⁶ (K⁻¹) and 20×10⁻⁶ (K⁻¹), respectively.

### (Step 7)

Next, a cathode terminal 7 was joined through a conductive adhesive layer 6 onto the silver layer 5b, and an anode terminal 8 was welded to the anode lead 1, whereby the terminals were electrically connected to the capacitor element 10a.

### (Step 8)

Next, a resin outer package 9 was formed by transfer molding using a resin composition containing an epoxy resin as a main ingredient to cover the capacitor element 10a and expose the ends of the cathode and anode terminals 7 and 8. The linear expansion coefficient of the resin outer package 9 was 40×10⁻⁶ (K⁻¹).

In the above manner, a solid electrolytic capacitor 10 according to this example was produced.

### Comparative Example 5

In Comparative Example 5, as shown in FIG. 9, a solid electrolytic capacitor was produced without forming a third electrolyte region 4c. In the process of producing the solid electrolytic capacitor, a conducting polymer was formed so that first and second electrolyte regions 4a and 4b had the same linear expansion coefficient (30×10⁻⁶ (K⁻¹)).

### Comparative Example 6

A solid electrolytic capacitor was produced in the same manner as in Comparative Example 5, except that a conducting polymer was formed so that first and second electrolyte regions 4a and 4b had the same linear expansion coefficient (7×10⁻⁶ (K⁻¹)).

### Comparative Example 7

A solid electrolytic capacitor was produced in the same manner as in Comparative Example 5, except that first and second electrolyte regions 4a and 4b were formed to have linear expansion coefficients of 7×10⁻⁶ (K⁻¹) and 15×10⁻⁶ (K⁻¹), respectively.

### Comparative Example 8

A solid electrolytic capacitor was produced in the same manner as in Comparative Example 5, except that first and second electrolyte regions 4a and 4b were formed to have linear expansion coefficients of 7×10⁻⁶ (K⁻¹) and 30×10⁻⁶ (K⁻¹), respectively.

### Comparative Example 9

A solid electrolytic capacitor was produced in the same manner as in Comparative Example 5, except that first and second electrolyte regions 4a and 4b were formed to have linear expansion coefficients of 15×10⁻⁶ (K⁻¹) and 30×10⁻⁶ (K⁻¹), respectively.

### Comparative Example 10

A solid electrolytic capacitor was produced in the same manner as in Example 20, except that first, second and third electrolyte regions 4a, 4b and 4c were formed to have linear expansion coefficients of 7×10⁻⁶ (K⁻¹), 15×10⁻⁶ (K⁻¹) and 7×10⁻⁶ (K⁻¹), respectively.

### Comparative Example 11

A solid electrolytic capacitor was produced in the same manner as in Example 20, except that first, second and third electrolyte regions 4a, 4b and 4c were formed to have linear expansion coefficients of 30×10⁻⁶ (K⁻¹), 15×10⁻⁶ (K⁻¹) and 30×10⁻⁶ (K⁻¹), respectively.

### [Evaluation Based on Heat Cycle Test]

Each of the produced solid electrolytic capacitors was subjected to a heat cycle test. The heat cycle test was conducted by repeating the cycle of allowing the capacitor to stand at −55° C. for 30 minutes and then allowing it to stand at 105° C. for 30 minutes 500 times. The capacitance, equivalent series resistance (ESR) and leakage current of each capacitor were measured before and after the heat cycle test, and from these measured values before and after the heat cycle test were calculated evaluation values according the following equation (2).

Percentage of evaluation value(%)={(measured value after heat cycle test)/(measured value before heat cycle test)}×100 (2)

Thus, each evaluation value is a value evaluated with reference to the measured value before the heat cycle test assigned 100.

The capacitance, ESR and leakage current of each capacitor were measured in the following manners.

### Measurement of Capacitance:

The capacitance of each capacitor at a frequency of 120 Hz was measured with an LCR meter.

### Measurement of ESR:

The ESR of each capacitor at 100 kHz was measured. Leakage Current:

A voltage of 2.5 V was applied to each capacitor, and the leakage current of the capacitor after five minutes was measured.

The measurement results are shown in Table 4.

TABLE 4

| | First | Second | Third | | | |
|---|---|---|---|---|---|---|
| | Electrolyte Region | Electrolyte Region | Electrolyte Region | | | Leakage |
| | (×10⁻⁶/K) | (×10⁻⁶/K) | (×10⁻⁶/K) | Capacitance | ESR | Current |
| Comp. Ex. 5 | 30 | 30 | — | 46 | 620 | 190 |
| Comp. Ex. 6 | 7 | 7 | — | 78 | 520 | 500 |
| Comp. Ex. 7 | 7 | 15 | — | 79 | 350 | 320 |
| Comp. Ex. 8 | 7 | 30 | — | 76 | 510 | 300 |
| Comp. Ex. 9 | 15 | 30 | — | 58 | 540 | 170 |
| Comp. Ex. 10 | 7 | 15 | 7 | 82 | 350 | 360 |
| Comp. Ex. 11 | 30 | 15 | 30 | 52 | 440 | 150 |
| Ex. 20 | 7 | 15 | 30 | 92 | 110 | 110 |

As shown in Table 4, Example 20, in which according to the second aspect of the present invention first, second and third electrolyte regions were provided and had increasing linear expansion coefficients in the order named, exhibited a high capacitance, a low ESR and a low leakage current even after the heat cycle test. This reveals that in Example 20 the reduction in capacitance and the increase in ESR and leakage current due to the heat cycle test were reduced and, therefore, Example 20 had a high reliability at high temperatures. In Comparative Examples 5 and 6, no third electrolyte region was provided, but first and second electrolyte regions were formed of conducting polymer layers having the same linear expansion coefficient. In Comparative Example 5, the first and second electrolyte regions had a linear expansion coefficient of 30×10⁻⁶ (K⁻¹), and the difference in linear expansion coefficient between the dielectric layer and the electrolyte layer was large. Therefore, it can be considered that Comparative Example 5 caused a delamination between the dielectric and electrolyte layers to deteriorate the capacitor characteristics. In Comparative Example 6, the first and second electrolyte regions had a linear expansion coefficient of 7×10⁻⁶ (K⁻¹), and the difference in linear expansion coefficient between the electrolyte layer and the resin outer package was large. Therefore, it can be considered that Comparative Example 6 caused a delamination between the electrolyte layer and part of the resin outer package around the anode lead to deteriorate the capacitor characteristics.

In Comparative Example 7, the difference in linear expansion coefficient between the second electrolyte region covering the side surface of the anode and the resin outer package was large. Therefore, it can be considered that Comparative Example 7 caused a delamination between the second electrolyte region and the resin outer package to deteriorate the capacitor characteristics.

In Comparative Example 8, it can be considered that a delamination between the dielectric and electrolyte layers and a delamination between the second electrolyte region and the resin outer package were reduced, but that a delamination between the first and second electrolyte regions and a delamination between the second electrolyte region and the cathode layer occurred to deteriorate the capacitor characteristics.

In Comparative Example 9, it can be considered that a delamination between the dielectric layer and the first electrolyte region occurred to deteriorate the capacitor characteristics.

A comparison among Example 20 and Comparative Examples and 11 reveals that it is preferable that the first, second and third electrolyte regions increase in linear expansion coefficient in the order named.

### Examples 21 to 23

### Example 21

A solid electrolytic capacitor was produced in the same manner as in Example 20, except that first, second and third electrolyte regions 4a, 4b and 4c were formed to have linear expansion coefficients of 5×10⁻⁶ (K⁻¹), 15×10⁻⁶ (K⁻¹) and 30×10⁻⁶ (K⁻¹), respectively.

### Example 22

A solid electrolytic capacitor was produced in the same manner as in Example 20, except that first, second and third electrolyte regions 4a, 4b and 4c were formed to have linear expansion coefficients of 10×10⁻⁶ (K⁻¹), 15×10⁻⁶ (K⁻¹) and 30×10⁻⁶ (K⁻¹), respectively.

### Example 23

A solid electrolytic capacitor was produced in the same manner as in Example 20, except that first, second and third electrolyte regions 4a, 4b and 4c were formed to have linear expansion coefficients of 12×10⁻⁶ (K⁻¹), 15×10⁻⁶ (K⁻¹) and 30×10⁻⁶ (K⁻¹), respectively.

### [Evaluation Based on Heat Cycle Test]

In the same manner as described previously, each of the above capacitors was subjected to a heat cycle test, and evaluated in terms of capacitance, ESR and leakage current. The measurement results are shown in Table 5.

TABLE 5

| | First | Second | Third | | | |
|---|---|---|---|---|---|---|
| | Electrolyte Region | Electrolyte Region | Electrolyte Region | | | Leakage |
| | (×10⁻⁶/K) | (×10⁻⁶/K) | (×10⁻⁶/K) | Capacitance | ESR | Current |
| Ex. 21 | 5 | 15 | 30 | 84 | 110 | 120 |
| Ex. 22 | 10 | 15 | 30 | 86 | 110 | 120 |
| Ex. 23 | 12 | 15 | 30 | 80 | 120 | 150 |

As is obvious from the results shown in Table 5, it is preferable that the linear expansion coefficient of the first electrolyte region be close to the linear expansion coefficient (7.1×10⁻⁶ (K⁻¹) of niobium forming the anode and not more than 10×10⁻⁶ (K⁻¹).

### Examples 24 to 26

### Example 24

A solid electrolytic capacitor was produced in the same manner as in Example 20, except that first, second and third electrolyte regions 4a, 4b and 4c were formed to have linear expansion coefficients of 7×10⁻⁶ (K⁻¹), 15×10⁻⁶ (K⁻¹) and 20×10⁻⁶ (K⁻¹), respectively.

### Example 25

A solid electrolytic capacitor was produced in the same manner as in Example 20, except that first, second and third electrolyte regions 4a, 4b and 4c were formed to have linear expansion coefficients of 7×10⁻⁶ (K⁻¹), 15×10⁻⁶ (K⁻¹) and 40×10⁻⁶ (K⁻¹), respectively.

### Example 26

A solid electrolytic capacitor was produced in the same manner as in Example 20, except that first, second and third electrolyte regions 4a, 4b and 4c were formed to have linear expansion coefficients of 7×10⁻⁶ (K⁻¹), 15×10⁻⁶ (K⁻¹) and 50×10⁻⁶ (K⁻¹), respectively.

### [Evaluation Based on Heat Cycle Test]

In the same manner as described previously, each of the above solid electrolytic capacitors was subjected to a heat cycle test, and evaluated in terms of capacitance, ESR and leakage current. The measurement results are shown in Table 6.

TABLE 6

| | First | Second | Third | | | |
|---|---|---|---|---|---|---|
| | Electrolyte Region | Electrolyte Region | Electrolyte Region | | | Leakage |
| | (×10⁻⁶/K) | (×10⁻⁶/K) | (×10⁻⁶/K) | Capacitance | ESR | Current |
| Ex. 24 | 7 | 15 | 20 | 92 | 180 | 180 |
| Ex. 25 | 7 | 15 | 40 | 92 | 120 | 120 |
| Ex. 26 | 7 | 15 | 50 | 91 | 190 | 200 |

The measurement results show that even if the third electrolyte region and the resin outer package have nearly equal linear expansion coefficients as in Example 25, the third electrolyte region can have a good contact with the resin outer package and, therefore, the occurrence of delamination or the like can be prevented or reduced. In addition, even if the third electrolyte region and the resin outer package have nearly equal linear expansion coefficients, the third electrolyte region can have a relatively good contact with the first and second electrolyte regions because they are made of the same conducting polymer. Therefore, it was found that such a solid electrolytic capacitor can have a high reliability at high temperatures.

The results for Examples 20, 24 and 25 show that it is preferable that the linear expansion coefficient of the third electrolyte region be smaller than that of the resin outer package. Furthermore, the results show that it is more preferable that the linear expansion coefficient be in the range of 30×10⁻⁶ (K⁻¹) to 40×10⁻⁶ (K⁻¹).

### Comparative Example in which Insulating Resin Layer is Formed Instead of Third Electrolyte Region

### Comparative Example 12

A solid electrolytic capacitor was produced in the same manner as in Example 20, except that first and second electrolyte regions 4a and 4b were formed to have linear expansion coefficients of 7×10⁻⁶ (K⁻¹) and 10×10⁻⁶ (K⁻¹), respectively, and that an insulating resin layer was formed, instead of a third electrolyte region, by applying a liquid epoxy resin. The linear expansion coefficient of the insulating resin layer was 30×10⁻⁶ (K⁻¹).

### [Evaluation Based on Heat Cycle Test]

The solid electrolytic capacitor produced in the above manner was subjected to a heat cycle test, and evaluated in terms of capacitance, ESR and leakage current. The measurement results are shown in Table 7.

TABLE 7

| | First | Second | Insulating | | | |
|---|---|---|---|---|---|---|
| | Electrolyte Region | Electrolyte Region | Resin Layer | | | Leakage |
| | (×10⁻⁶/K) | (×10⁻⁶/K) | (×10⁻⁶/K) | Capacitance | ESR | Current |
| Comp. Ex. 12 | 7 | 15 | 30 | 91 | 330 | 300 |

The results shown in Table 7 reveals that, as compared with Example 20, Comparative Example 12 significantly increased the ESR and leakage current. We believe the reason for this is that because the insulating resin layer formed in place of the third electrolyte region had no conductivity, the ESR was high. Furthermore, we believe that because the insulating resin layer had a different ingredient from the second electrolyte region, a mismatch occurred at the interface between the insulating resin layer and the second electrolyte region to cause a delamination between them, which increased the ESR and leakage current.

### Other Embodiments

Although in the above embodiment and examples a second electrolyte region 4b is formed over the side surface 2a of the anode 2 and on the first electrolyte region 4a, the structure of the electrolyte layer is not limited to this in the second aspect of the present invention. As shown in FIG. 7, the second electrolyte region 4b may not be formed over the side surface 2a of the anode 2 and on the first electrolyte region 4a, that is, the third electrolyte region 4c may be formed over the side surface 2a of the anode 2 and directly on the first electrolyte region 4a. Such a solid electrolytic capacitor can be produced by dipping the anode into a chemically polymerizable liquid for forming a second electrolyte region in Step 4 of Example 20 to such a depth that the liquid level of the chemically polymerizable liquid does not touch the side surface 2a of the anode 2.

What is claimed is:

1. A solid electrolytic capacitor comprising:
an anode made of a valve metal or an alloy of a valve metal;
a dielectric layer formed on the surface of the anode;
an electrolyte layer formed on the dielectric layer;
a cathode layer formed on the electrolyte layer; and
a resin outer package covering a capacitor element composed of the anode, the dielectric layer, the electrolyte layer and the cathode layer,
wherein the electrolyte layer is composed of a first electrolyte region provided on the dielectric layer, a second electrolyte region provided on the first electrolyte region and in contact with the cathode layer, and a third electrolyte region provided in contact with a portion of the second electrolyte region or the first electrolyte region on which the cathode layer is not provided.

2. The solid electrolytic capacitor of claim 1, wherein the portion of the second electrolyte region or the first electrolyte region on which the cathode layer is not provided is a side surface of the anode, and an anode lead is provided at the side surface of the anode with a part thereof embedded in the anode.

3. The solid electrolytic capacitor of claim 1, wherein the hardness of each of the first and third electrolyte regions is lower than that of the second electrolyte region.

4. The solid electrolytic capacitor of claim 1, wherein the thickness ratio of the third electrolyte region to the second electrolyte region (third electrolyte region thickness/second electrolyte region thickness) is in the range of 0.1 to 10.

5. A solid electrolytic capacitor comprising:
an anode made of a valve metal or an alloy of the valve metal;
a dielectric layer formed on the surface of the anode;
an electrolyte layer formed on the dielectric layer;
a cathode layer formed on the electrolyte layer; and
a resin outer package covering a capacitor element composed of the anode, the dielectric layer, the electrolyte layer and the cathode layer,
wherein the electrolyte layer is composed of a first electrolyte region provided on the dielectric layer, a second electrolyte region provided on the first electrolyte region and in contact with the cathode layer, and a third electrolyte region provided in contact with a portion of the second electrolyte region or the first electrolyte region on which the cathode layer is not provided, and
linear expansion coefficients of the first, second and third electrolyte regions increase in the order named.

6. The solid electrolytic capacitor of claim 5, wherein the portion of the second electrolyte region or the first electrolyte region on which the cathode layer is not provided is a side surface of the anode, and an anode lead is provided at the side surface of the anode with a part thereof embedded in the anode.

7. The solid electrolytic capacitor of claim 5, wherein the linear expansion coefficient of the first electrolyte region is 10×10⁻⁶ (K⁻¹) or less.

8. The solid electrolytic capacitor of claim 5, wherein the linear expansion coefficient of the second electrolyte region is smaller than that of the cathode layer.

9. The solid electrolytic capacitor of claim 5, wherein the linear expansion coefficient of the third electrolyte region is smaller than that of the resin outer package.

10. The solid electrolytic capacitor of claim 5, wherein the linear expansion coefficient of the third electrolyte region is in the range of 30×10⁻⁶ (K⁻¹) to 40×10⁻⁶ (K⁻¹).
